(19) United States
(12) Patent Application Publication
(10) Pub. No.: US 2010/0129149 A1
(43) Pub. Date: May 27, 2010

(54) FASTENING DEVICE FOR FASTENING OBJECTS TO A BASE SURFACE

(75) Inventors: Daniel Metz, Karlsdorf-Neuthard (DE); Volkmar Uebele, Bad Nauheim (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/598,492

(22) PCT Filed: Apr. 29, 2008
(86) PCT No.: PCT/EP08/55203

§ 371 Date: Nov. 2, 2009

(30) Foreign Application Priority Data
May 9, 2007 (DE) 10 2007 021 731.7

(51) Int. Cl. F16B 2/18

(52) U.S. Cl. 403/409.1

(57) ABSTRACT

A fastening device for fastening a range hood housing of a range hood to a base surface. The fastening device includes a mandrel that can be fastened to the base surface; an eccentric disk that is rotabably arranged on the mandrel; and a receiving groove that is formed, at least area by area, by the outer lateral area of the eccentric disk and that receives at least a section of the range hood housing.

The invention relates to a fastening device for fastening objects, particularly a range hood housing of a range hood, to a base surface. The invention further relates to the use of such a fastening device.

Fastening devices serve to fasten objects to a base surface. The base surface can be part of a building, a part of a wall, a ceiling, a pillar, a framework or the like.

All possible kinds of objects, in particular heavy objects, can be fastened to a base surface by means of a fastening device. Thus, the objects may, for example, be electronic equipment such as flat-screen televisions, kitchen appliances, furniture, etc. These are fastened to relevant base surfaces such as, for example, room walls.

Thus, for example, a range hood housing of a range hood is fastened by means of screws, which are inserted through openings in the rear wall and/or a side wall of the range hood housing, to a wall, in particular a building wall or room wall. To this end, the screws are generally screwed into plugs which are inserted into the wall. To fasten a range hood housing of a range hood, it is also known for the range hood housing to be suspended on retaining hooks.

A disadvantage of these types of fastenings is that assembly and alignment of the objects are elaborate. Also, in the case of a simple fastening by means of screws, subsequent alignment of the objects is not possible.

The object of the present invention is therefore to create a fastening device for fastening objects, in particular heavy objects such as a range hood housing of a range hood, to a base surface, by means of which fastening device it is possible to fasten the objects very easily, in particular almost without the aid of tools. Furthermore, the fastening device is designed to make it very easy for the object being fastened to be aligned on the base surface.

The invention is based upon the recognition that this object can ideally be achieved in a fastening device or in the use of a fastening device for fastening objects, in particular a range hood housing of a range hood, to a base surface, the fastening device comprising a positionally adjustable section of a receiving groove in order to hold at least one region of the object.

Features and details which are described in respect of the fastening device shall of course also apply in respect of the use of such a fastening device, and vice versa.

The object is therefore achieved according to the invention in a fastening device for fastening objects, in particular a range hood housing of a range hood, to a base surface, the fastening device comprising a mandrel for fastening to the base surface, an eccentric disk, which is rotatably arranged on the mandrel, and a receiving groove for receiving at least one region of the object, the groove being formed by the outer lateral surface of the eccentric disk at least in regions.

A base surface is deemed in the light of the invention to be any surface to which the fastening device can be fastened. The surface has only to be marginally larger than the fastening device itself. The base surface has to be fashioned such that it can hold the fastening device in a materially bonded and/or force-locking manner. Thus, the base surface can be part of a building, a building wall or cabinet wall, a ceiling, a pillar, a framework or similar.

The objects to be fastened can be highly diverse. Thus, in particular, electronic equipment such as a flat screen or kitchen equipment such as range hoods can be fastened by the fastening device. Furthermore, the objects can also be fashioned as pieces of furniture or such like. Clad objects, in particular, can preferably be fastened with such a fastening device, if the fastening device is not visible after the cladding of the objects has been attached.

Thus, a range hood housing of a range hood can preferably be fastened to a base surface, such as a room wall. The fastening of the range hood housing is no longer visible after the cladding of the range hood has been attached.

The fastening device comprises a mandrel, which can be fastened to the base surface. The fastening of the mandrel to the base surface can be fashioned in a variety of ways. That is, the fastening can be effected in a materially bonded and/or force-locking manner. Thus, the mandrel can be welded, glued or, preferably, screwed to the base surface. To this end, the mandrel has to have only one weldable, gluable or screwable surface. The fastening device comprises furthermore an eccentric disk, which is rotatably arranged on the mandrel. The eccentric disk is arranged on the mandrel such that the longitudinal axis of the mandrel and the axis of rotation of the eccentric disk lie coaxially with one another. The central axis of the hollow-profile-shaped eccentric disk is arranged at a defined distance parallel to the axis of rotation of the eccentric disk and to the central axis of the mandrel. The eccentric disk constitutes an eccentrically mounted structure, which is rotatably arranged on the mandrel. The eccentric disk has a hollow-profile-shaped form for receiving the mandrel. The eccentric disk converts a rotational movement into a lifting movement perpendicular to the axis of rotation.

The fastening device comprises furthermore a receiving groove for receiving at least one region of the object, which is formed at least in regions by the outer lateral surface of the eccentric disk. A corresponding region or a corresponding part of the object to be fastened can be inserted, particularly in a form-locking manner, into the formed receiving groove. The region of the object to be fastened may, for example, be a retaining plate or a wall element or a housing element. This region is held in the receiving groove firstly by the dimension of the receiving groove, in particular the width thereof, which corresponds to the thickness of the region. Secondly, the weight of the object, the region of which has been inserted into the receiving groove, acts such that the region is held in the receiving groove. The receiving groove consequently holds the region of the object inserted into the receiving groove and thus the object securely to the fastening device. The object can therefore be fastened by the fastening device to a base surface very easily, almost without additional tools.

The position of the section of the receiving groove in which the region of the object is held can be altered by rotating the eccentric disk, such that the held object can be aligned vertically. The fastened object can be aligned vertically on the base surface to a greater or lesser degree as a function of the degree of eccentricity of the eccentric disk. The eccentric disk is preferably rotated about the mandrel before the object is inserted into the receiving groove such that the section of the receiving groove in which the region of the object is received in said groove can, through rotation of the eccentric disk, be moved closer toward the axis of rotation or further away from the axis of rotation of the eccentric disk. Based on this starting position of the eccentric disk, it is thus possible to raise or lower the object held in the receiving groove by rotating the eccentric disk. Alignment of the receiving groove and of the fastened object can be effected manually, i.e. by gripping and rotating the eccentric disk. The object can also be displaced horizontally along the receiving groove. The extent to which the object can be displaced horizontally depends on the object itself, in particular on the width of the cutouts in the object.

The receiving groove is formed at least in regions by the outer lateral surface of the eccentric disk. The outer lateral surface is, in the light of the invention, formed by the exterior of the eccentric disk. A face which is formed by a bend on the outside is also understood here to form part of the outer lateral surface. The receiving groove can be formed, for example, by a region of the outer lateral surface of the eccentric disk and by the base surface to which the fastening device is fastened. The fastening of the fastening device to a base surface forms, for example, a radially-oriented receiving groove, the sides of which are formed by a region of the face of the outer lateral surface of the eccentric disk and by the base surface. The bottom of the receiving groove is preferably formed by the outer lateral surface of the eccentric disk, in particular by a recess on the face. It is also conceivable for the receiving groove to be formed by the outer lateral surface of the eccentric disk and a washer, through the drill hole of which the mandrel has been fastened to the base surface. Such a fastening of the object in the receiving groove has the advantage that the base surface is not damaged by the inserted object. Furthermore, it is also possible for the receiving groove to be inserted into the outer circumference of the eccentric disk, in particular close to one of the faces of the eccentric disk.

Depending on the size and material of the fastening device, light or heavy objects can be fastened to a base surface almost without tools. Only the fastening device is fastened to the base surface. The fastening device, i.e. the mandrel and the eccentric disk, is preferably sufficiently large and fashioned from a material of such high strength and stability that heavy objects, such as for example the range hood housing of a range hood, can be fastened to a room wall, a cabinet wall or a fastening plate and held by the fastening device. The mandrel and the eccentric disk can be manufactured, for example, out of plastic or metal.

The eccentric disk is preferably inseparably eccentrically connected to the mandrel. In a particularly preferable embodiment, a friction-locked connection exists between the eccentric disk and the mandrel. In this case, the eccentric disk is rotatable about the mandrel only when a certain force is exerted. The mandrel and the eccentric disk are preferably fashioned from a hard plastic. They are preferably inseparably joined to one another by means of a so-called “hard/hard” or “hard on hard” injection molding method. For this purpose, special high-temperature-resistant plastics are used as a metal substitute. In the manufacture of the fastening device, the mandrel or the eccentric disk can be used as a pre-molded part. If the mandrel serves as the pre-molded part, the eccentric disk is injected onto the mandrel. If the eccentric disk serves as the pre-molded part, the mandrel is injected into the eccentric disk. The mandrel and eccentric disk are in this way fastened to one another in a form-locking manner. Rotation of the eccentric disk remains possible only if a certain force is exerted, i.e. the friction-locked connection is overcome.

A preferred embodiment is a fastening device in which the receiving groove is provided in the outer lateral surface of the eccentric disk over at least a region of the circumference. Here, the receiving groove is preferably fashioned as a radial groove. The receiving groove can run over a region or section of the circumference or over the entire circumference, i.e. circumferentially. It is also possible for several receiving grooves to be arranged along the circumference of the outer lateral surface. The receiving groove is in this embodiment of the fastening device formed exclusively by the eccentric disk. This has the advantage that the receiving groove can easily be produced and its width set when the eccentric disk is manufactured. Furthermore, the base surface, to which the fastening device is fastened, is protected during insertion of the at least one part of the object to be fastened. The fastened object does not necessarily have to be fastened at a spacing from the base surface. The region of the object which is fastened to the base surface by the fastening device can thus be arranged inwardly offset on the object. This means that, depending on the shape of the object, the object can lie directly against the base surface, even though the fastening of the object is effected at a spacing from the base surface. If the fastened object is subsequently clad, the spaced fastening of the object on the base surface is not generally disadvantageous.

Another preferred embodiment of the fastening device provides that the mandrel of the fastening device has a base plate. The base plate forms, together with at least one region of the outer lateral surface of the eccentric disk, the receiving groove. The mandrel projects vertically out of the base plate. The base plate consequently forms a reinforcement of the mandrel. The base plate enlarges the area which is available for fastening the mandrel to the base surface. Thus, the base plate can be fastened to the base surface in a materially bonded and/or force-locking manner, in particular by means of a welded joint and/or a screw connection. The base plate of the mandrel may, for a force-locked fastening to the base surface, have several drill holes through which screws can be guided. Furthermore, it is possible for the base plate to be fastened to the base surface by means of latching elements. The base plate is in this case fashioned sufficiently large that it can form, with at least one region of the outer lateral surface of the eccentric disk, the receiving groove. In particular, one region of the face of the outer lateral surface of the eccentric disk forms in this case a side of the receiving groove, while the other side of the receiving groove is formed by the base plate. With this fastening, the base surface, to which the fastening device is fastened, is protected. In addition, in this embodiment the width of the receiving groove can also be set during production of the fastening device.

A particularly advantageous embodiment is a fastening device in which both the mandrel and the eccentric disk have a through-opening for a fastening screw to be guided through. The through-opening can be introduced by drilling into the eccentric disk and the mandrel. Preferably, however, these through-openings are formed during manufacture of the mandrel and the eccentric disk, for example during the injection molding of these parts. The through-openings in the mandrel and the eccentric disk are arranged concentrically with one another, such that a screw can be guided though the two through-openings so as to be screwed into a corresponding slot in the base surface. A tool has to be used only for screwing the screw into the corresponding slot. Thereafter, no further tool is used. Such a design of the fastening device makes it possible for the fastening device to be fastened to the base surface in a particularly simple and fast manner. Furthermore, the through-openings can be fashioned so as to be relatively large such that secure fastening of the fastening device to the base surface is ensured by means of a correspondingly large screw. The through-openings in the mandrel and/or in the eccentric disk run preferably coaxially with the longitudinal axis of the mandrel or the axis of rotation of the eccentric disk. Such a fastening of the fastening device to the base surface, i.e. for example to a wall, has, in addition to the secure fastening, the advantage that the fastening cannot be seen externally, since the fastening screw inserted into the through-openings can be at least partially countersunk. Such a countersunk fastening screw can easily be detached from the base surface by inserting a spanner through the through-openings.

The mandrel of the fastening device preferably comprises at least one latching projection for engaging behind at least one edge on the inner lateral surface of the eccentric disk in a form-locking manner. The eccentric disk is hereby arranged securely on the mandrel. As a result, axial movement of the eccentric disk along the longitudinal axis of the mandrel is impossible in one direction. Axial movement of the eccentric disk in the opposing direction along the longitudinal axis of the mandrel is prevented either by a further latching projection for engaging behind a second edge on the inner lateral surface of the eccentric disk in a form-locking manner or by the base plate of the mandrel. This ensures that the eccentric disk is only rotatably mounted on the mandrel. The edge on the inner lateral surface of the eccentric disk runs preferably perpendicularly to the axis of rotation of the eccentric disk. The edge can, however, also run inclinedly relative to the axis of rotation of the eccentric disk. The inner lateral surface of the eccentric disk is deemed here to refer to the wall of the eccentric disk which encircles the axis of rotation of the eccentric disk.

The outer lateral surface of the eccentric disk of the fastening device is advantageously fashioned in the shape of a conical frustum. By this means, after the fastening device has been fastened to a base surface, a cutout in the at least one region of the object, in particular a cutout with a horizontally oriented upper edge, can easily be placed or pushed over the eccentric disk, and the cutout or the horizontally oriented upper edge of the cutout guided into the receiving groove. The outer lateral surface of the eccentric disk advantageously has a slight incline relative to the surface of the cone. This prevents an object which has not been fastened properly from easily slipping off the fastening device. An eccentric disk of such a shape consequently prevents the object from falling down if fastened incorrectly or during fastening.

A further preferred embodiment is a fastening device in which the eccentric disk has at least one drill hole running inclinedly, in particular perpendicularly, to the axis of rotation of the eccentric disk. This drill hole, too, can be introduced by drilling into the eccentric disk. Alternatively, the drill hole can be manufactured or cut out during manufacture of the eccentric disk or during injection molding. The drill hole can be used as a slot for a lever for rotating the eccentric disk. Thus, for example, a screwdriver can be inserted into the drill hole in order to rotate the difficult-to-rotate eccentric disk by means of the leverage of the screwdriver. Particularly with heavy objects which are fastened to the wall by means of the fastening device, the provision of a drill hole inclined to the axis of rotation of the eccentric disk is advantageous. After a region of the object has been received in the receiving groove of the fastening device, the weight of the object acts upon the eccentric disk such that the latter can be turned only through the exertion of an increased force. The force required can readily be applied by inserting a lever. In this manner, the position of the section of the receiving groove in which the region of the object is received and thus the position of the object can be altered more easily.

A further preferred embodiment is a fastening device in which the fastening device has a cap which can be fastened to the eccentric disk in a form-locking or force-locking manner. The cap is pulled over the eccentric disk such that the eccentric disk is no longer accessible from the outside. The cap therefore advantageously has the form of a conical frustum-shaped container. The cap can, however, also be fashioned differently. After the cap has been fastened onto the eccentric disk, the cap preferably lies with the open face at least partially against the fastened region of the object. The cap can be fastened to the eccentric disk in a form-locking manner. The form-locking connection can be effected by means of at least one latching element on the inner lateral surface of the cap. The latching element engages behind or engages in a projection, an indentation, a groove or an undercut on the outer lateral surface of the eccentric disk. The latching element can be fashioned in a radially encircling manner on the inner lateral surface of the cap. It is, however, also conceivable for a plurality of latching elements to be provided on the inner lateral surface of the cap, which elements engage in a corresponding plurality of indentations, grooves, projections and/or undercuts on the outer lateral surface of the eccentric disk. This prevents the possibility of the cap being removed from the eccentric disk or of falling off it. The cap protects the eccentric disk and strengthens the fastening of the object to the base surface. The projection, the indentation, the groove or the undercut on the outer lateral surface of the eccentric disk serve furthermore, before the cap has been fixed on the eccentric disk, to safeguard the mounting process. That is, if the object is inserted in the receiving groove incorrectly, the projection, the indentation, the groove or the undercut on the outer lateral surface of the eccentric disk prevent the object from slipping down.

The projections, indentations, grooves or undercuts provided on the outer lateral surface of the eccentric disk also create, in addition to a facility for fastening the cap, a catch protection when the object is being mounted in the receiving groove. If the region of the object does not reliably engage with the receiving groove and the object is released by the fitter, then if the outer lateral surface of the eccentric disk were smooth, the object would slide down the eccentric disk, which is preferably conical-frustum-shaped. The provision of preferably circumferential ribs or grooves can prevent this.

In addition, the cap is designed such that in the mounted position on the eccentric disk it abuts at least partially against the region of the object and thus forms a force-locking connection with the region of the object. The abutting of the cap against the fastened region of the object, which is held in the receiving groove, additionally secures this region in the receiving groove. The region of the object may, for example, be the rear wall of a range hood housing.

A further preferred embodiment is a fastening device in which the cap has at its open end at least in regions limb elements arranged in an angled manner, said limb elements being oriented toward the central axis of the cap and/or away from the central axis of the cap, in particular perpendicularly to the central axis of the cap. These limb elements, arranged in an angled manner at least in regions, can be inserted into regions of the receiving groove which are not occupied by the inserted region of the object. These are, in particular, the lateral region of the receiving groove and/or the region of the receiving groove below the mandrel. Other limb elements arranged in an angled manner, in particular limb elements angled outwardly, abut against the fastened region of the object. The engaging and abutting of the limb elements arranged in an angled manner makes it additionally possible for the part of the object fastened in the receiving groove to be fastened to the eccentric disk in a form-locking and/or force-locking manner and additionally for rotation of the eccentric disk to be prevented. This fastening also provides a means preventing decoupling of the region of the object on the receiving groove.

The eccentric disk of the fastening device preferably has knurls on the outer lateral surface. The eccentric disk can in this way more readily be manually rotated in order to align the suspended object vertically. The knurls, which form, for example, grooves or indentations running axially and provided in particular on the outside of the eccentric disk, offer a firmer grip for gripping of the eccentric disk.

Knurls are preferably also provided on the inner lateral surface of the cap. These knurls are preferably aligned with the knurls of the eccentric disk and engage, when the cap is fastened, with the knurls on the outer lateral surface of the eccentric disk. The cap is by this means guided securely when being placed on until the latching elements of the cap lock into corresponding indentations, grooves, etc. on the eccentric disk.

A further preferred embodiment is a fastening device in which the cap has cutouts, in particular in the region of the latching elements. The latching elements, which are preferably fashioned in a spring elastic manner, can by this means be removed from the indentations, grooves or undercuts of the eccentric disk by inserting a lever tool, in order in this way to remove the cap from the eccentric disk. The cap is preferably manufactured out of plastic.

According to a second aspect of the invention, the object of the invention is achieved through the use of at least one fastening device, described hereinabove, for fastening a rear wall of a range hood housing of a range hood to a base surface, the rear wall of the range hood housing having at least one cutout for the mandrel and the eccentric disk to be guided through.

The rear wall of a range hood housing of a range hood can be fastened simply and securely to a wall by means of two such fastening devices. The rear wall has two cutouts for fastening to the fastening devices. After the fastening devices have been fastened to the wall, the fastening devices being fastened to the wall at approximately the same height and spaced at a distance which matches the distance between the two cutouts, the two cutouts in the rear wall are pushed over the fastening devices and hooked into the respective receiving grooves of the two fastening devices. The rear wall sits on the edges of the cutouts, in particular with the upper edge of the cutout in a form-locking manner in the receiving grooves of the fastening devices. To align the rear wall and thus the range hood housing of the range hood vertically, the eccentric disks can be rotated about the mandrels respectively provided therein until the range hood housing is arranged horizontally on the wall. After being aligned vertically, the range hood housing can, depending on the size of the cutouts, be displaced horizontally, until the perfect position has been found here, too. Due to the friction lock which preferably exists between the mandrel and the eccentric disk, the eccentric disks will remain in the rotated position originally set even during horizontal adjustment of the range hood housing. Subsequently, caps are placed over each eccentric disk, which additionally impede rotation of the eccentric disk and additionally secure the rear wall in the receiving grooves. The rear wall can by this means no longer be removed from the fastening in the receiving grooves.

The fastening devices ensure that the range hood housing of the range hood is held securely on the wall. Fastening is very simple, as the fastening of the range hood housing of the range hood to the fastening devices can be effected without tools. Vertical alignment of the eccentric disks is effected by rotating the eccentric disks manually or with the aid of a lever tool, such as a screwdriver. To remove the range hood housing from the fastening devices, firstly the caps are released from the fastening devices. Then, the range hood housing can simply be lifted vertically out of the receiving grooves and removed horizontally over the fastening devices.

The invention will be described below with the aid of the accompanying drawings, which represent possible embodiments of the invention and in which:

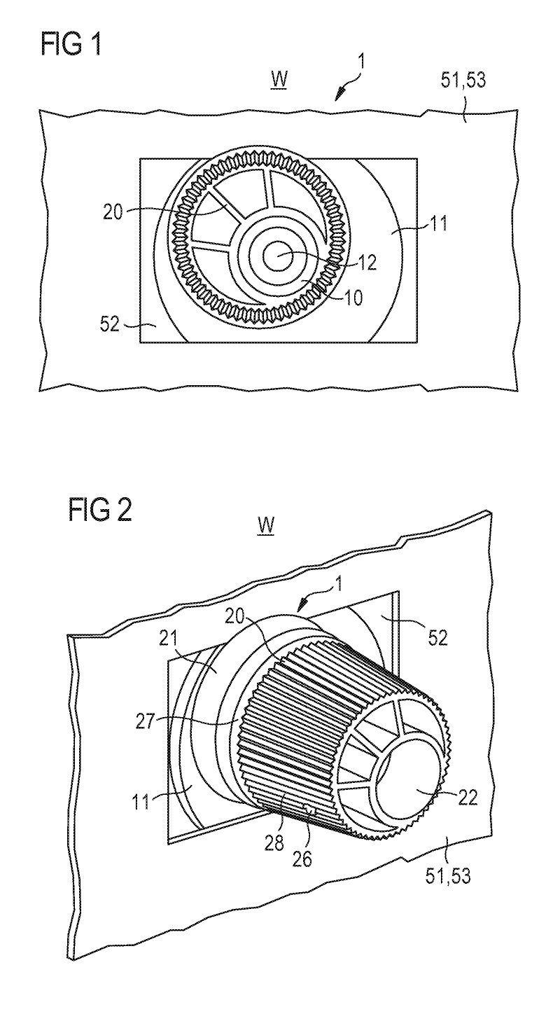

FIG. 1 shows a front view of a region of an object which is fastened to a fastening device,

FIG. 2 shows a perspective view of a region of an object which is fastened to a fastening device;

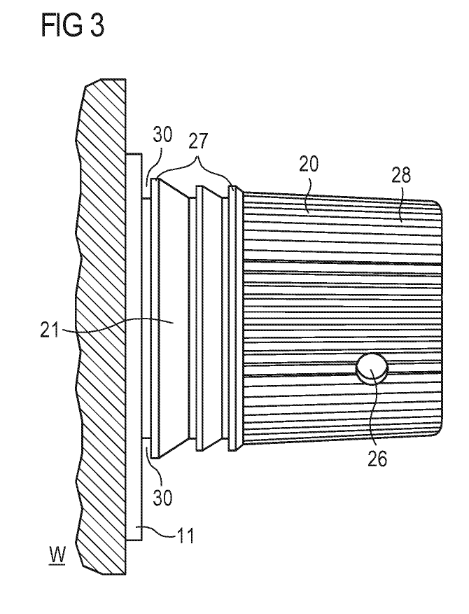

FIG. 3 shows a side view of an eccentric disk with base plate of a fastening device;

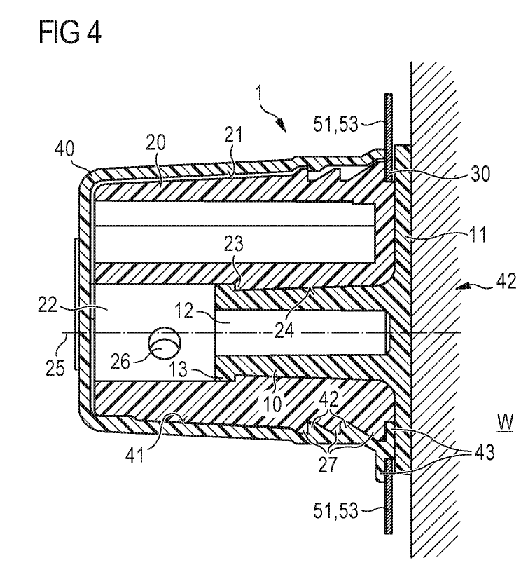

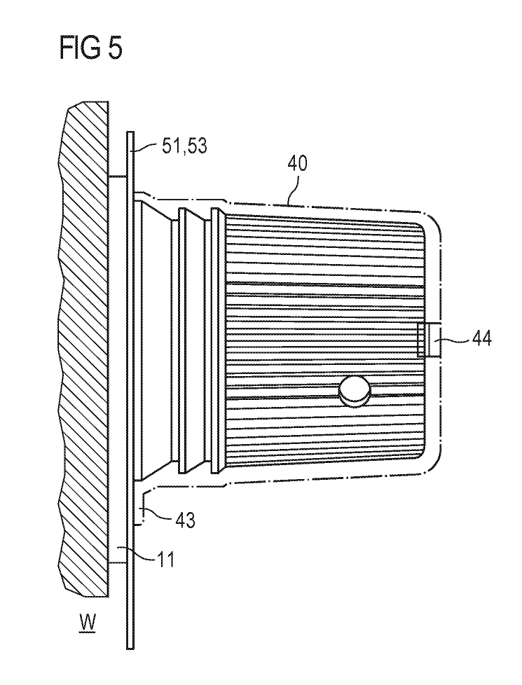

FIG. 4 shows a sectional view though a fastening device;

FIG. 5 shows a side view of a region of an object fastened to a fastening device; and

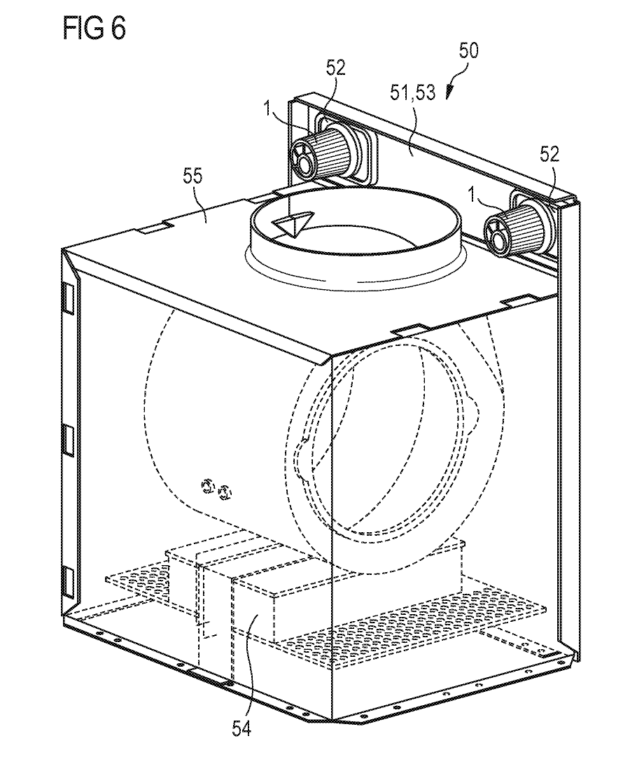

FIG. 6 shows a perspective view of a range hood housing fastened to two fastening devices.

FIG. 1 shows a perspective view of a region 53 of an object, here a rear wall 51 of a range hood housing, which is fastened to a fastening device 1. The fastening device 1 has a mandrel 10 which has a through-opening 12 for fastening the mandrel 10 to a base surface W, for example a wall. The mandrel 10 also has a base plate 11, which is designed for fastening to the base surface. The mandrel 10 projects preferably perpendicularly out of the base plate 11. There is provided in the mandrel 10 a through-opening 12, which thus allows penetration of a fastening screw (not shown) from the front of the fastening device 1 to the base surface W. An eccentric disk 20 is rotatably mounted on the mandrel 10. The eccentric disk 20 is arranged in a friction-locked manner on the mandrel 10 such that this eccentric disk can be rotated about the mandrel 10 only by exerting an increased force. The eccentric disk 20 can be rotated manually. The rear wall 51 of the range hood housing has a cutout 52 which has a height and a width which are greater than the diameter of the eccentric disk 20 on the side on which the eccentric disk 20 faces the base plate 11. The eccentric disk 20 can be guided through the cutout 52 of the back wall 51 until the upper edge of the cutout 52 is fastened in a receiving groove 30, which is not shown in this figure.

After the rear wall 51 has been suspended, this rear wall can be displaced vertically by rotating the eccentric disk 20, i.e. the eccentric disk 20 enables vertical alignment of the fastened rear wall 51 by means of rotation. The central axis of the eccentric disk 20 lies spaced at a distance axis—parallel to the axis of rotation of the eccentric disk 20. In this way, the formed receiving groove 30 in the section thereof directed toward the upper edge of the cutout 52 can be lowered or raised by rotating the eccentric disk 20, in order thereby to align the rear wall 51.

FIG. 2 shows the eccentric disk 20 in perspective view. The through-opening 22 of the eccentric disk 20 can also be discerned here. The eccentric disk 20 has knurls 28 on the outer lateral surface 21 which offer a better hold when the eccentric disk 20 is gripped. The knurls 28 also serve to guide a push-on cap, (see FIG. 4) which likewise has corresponding knurls on the inner lateral surface 41. Furthermore, the knurls 28 on the outer lateral surface 21 of the eccentric disk 20 serve to hold the cap 40 rotationally securely on the eccentric disk 20. Also shown on the outer lateral surface 21 of the eccentric disk 20 are radially circumferential projections or ribs 27. These are located in the region of the eccentric disk 20 facing the base plate 11 of the mandrel 10. The projections 27 serve to fix the cap 40, shown in FIG. 4, to the eccentric disk 20. The projections 27 do not necessarily have to run the entire circumference of the outer lateral surface 21 of the eccentric disk 20. They can also be provided singly about the circumference of the outer lateral surface 21 of the eccentric disk 20. Furthermore, indentations, grooves and/or undercuts can be provided in place of the projections 27. The projection 27 or an indentation, a groove or an undercut on the outer lateral surface 21 of the eccentric disk 20 serves furthermore to safeguard the mounting process, before the cap 40 is fixed to the eccentric disk 20. That is, if the rear wall 51 of a range hood housing 50 is incorrectly inserted into the receiving groove 30, then the projection 27, or alternatively an indentation, a groove or an undercut, on the outer lateral surface 21 of the eccentric disk 20 prevents the range hood housing 50 from sliding down. The eccentric disk 20 has furthermore a drill hole 26, in particular a transverse drill hole, which can serve as a slot for a lever for rotating the eccentric disk 20. Thus, for example, a screwdriver can be inserted as a lever into the drill hole 26, the screwdriver simplifying rotation of the eccentric disk 20 about the mandrel 10.

FIG. 3 shows a side view of a fastening device 1. The eccentric disk 20 sits rotatably on the mandrel 10, the base plate 11 of which is visible. The eccentric disk 20 has on the outer lateral surface 21 knurls 28 which offer a better hold when the eccentric disk 20 is gripped. This view also shows the drill hole 26 which serves as a slot for a lever for rotating the eccentric disk 20. Shown on the outer lateral surface 21 of the eccentric disk 20 are three projections 27 running radially along the circumference of the outer lateral surface 21, which serve to receive latching elements 42 of an attachable cap 40 (FIG. 4). The outer lateral surface 21 of the eccentric disk 20 has on its region facing the base plate 11 of the mandrel 10 an indentation or edge which, together with the base plate 11 of the mandrel 10, forms the receiving groove 30. The receiving groove 30 is consequently formed by a part, in particular a face, of the outer lateral surface 21 of the eccentric disk 20 and a part of the base plate 11 of the mandrel 10. A part of the outer lateral surface 21 of the eccentric disk 20 running parallel to the longitudinal axis of the eccentric disk 20 forms the bottom of the receiving groove 30. The region 53 (not shown) of the object, for example a rear wall 51 of a range hood housing, can be inserted into the receiving groove 30 and fastened.

FIG. 4 shows a section through a fastening device 1. The axis of rotation 25 of the eccentric disk 20 lies coaxially with the longitudinal axis of the mandrel 10. The through-opening 12 also runs coaxially with the longitudinal axis of the mandrel 10. The eccentric disk 20 has a through-opening 22 arranged in alignment with the through-opening 12 of the mandrel 10. A plug is inserted into the base surface W for receiving a fastening screw (not shown), which is screwed in through the through-opening 22 of the eccentric disk 20 and the through-opening 12 of the mandrel 10. The mandrel 10 has a base plate 11 and a through-opening 12. The mandrel 10 also has on the end facing away from the base plate 11 a latching projection 13 for engaging behind at least one edge 23 on an inner lateral surface 24 of the eccentric disk 20 in a form-locking manner. Axial displacement of the eccentric disk 20 on the mandrel 10 is prevented on the one hand by the latching projection 13 and on the other hand by the base plate 11 of the mandrel 10. That is, the eccentric disk 20 lies in a form-locking manner between the latching projection 13 and the base plate 11 of the mandrel 10.

The centerline of the eccentric disk 20 runs spaced at a distance parallel to the axis of rotation 25 of the eccentric disk 20. In this way, the receiving groove 30, in particular the upper section of the receiving groove 30, can be varied in vertical position by rotating the eccentric disk 20. The outer lateral surface 21 of the eccentric disk 20 has, on its region facing the base plate 11 of the mandrel 10, an indentation which, together with the base plate 11 of the mandrel 10, forms the receiving groove 30.

The rear wall 51 is inserted into the receiving groove 30 and fastened there.

Projections 27 are provided on the outer lateral surface 21 of the eccentric disk 20, which receive in a form-locking and/or force-locking manner latching elements 42 which are arranged on the inner lateral surface 41 of an attached cap 40. At the open end 42 of the cap 40, limb elements 43 are provided which abut in regions against the rear wall 51 and in part engage in the receiving groove 30. On the lower region of the cap 40 in FIG. 4, there are provided both a limb element 43 inclined outwardly over the cap 40 and a limb element 43 inclined into the interior of the cap 40. The outwardly oriented limb element 43 abuts against the front of the region 53, i.e. projects downward over the cutout 52. The inwardly oriented limb element 43 engages with the lower section of the receiving groove 30. By this means, the rear wall 51 of the range hood housing is secured in the receiving groove 30 such that this wall is firmly fixed to the fastening device 1. A slight degree of play may be present when the rear wall 51 is inserted in the receiving groove 30, but gravity will pull the range hood housing firmly into the receiving groove 30.

The rear wall 51, in particular the upper edge of the cutout 52 of the rear wall 51, can be inserted into the receiving groove 30. Due to the weight of the rear wall 51, the latter will sit firmly in the receiving groove 30. After the rear wall 51 has been inserted into the receiving groove 30, the cap 40 is fixed to the eccentric disk. The cap 40 is preferably fashioned such that it can be pushed onto the eccentric disk 20 in a form-locking or approximately form-locking manner. The open end 42, or the face of the open end 42, of the cap 40 sits after fastening on the eccentric disk 20 partially against the rear wall 51 of the range hood housing. Limb elements 43, which are arranged at the open end 42 of the cap 40 engage partially with the cutout 52 of the rear wall 51 and partially with the receiving groove 30 and thereby secure the rear wall 51 of the range hood housing to the fastening device 1. On the inner lateral surface 41 of the cap 40, latching elements 42 can be provided which lock into place on the radially circumferential projections 27 on the outer lateral surface 21 of the eccentric disk 20. FIG. 5 shows a region 53 of the rear wall 51 fastened to the fastening device 1. In this view, a cutout 44 can also be discerned, through which the latching elements 42 arranged on the inner lateral surface 41 of the cap 40 can be released.

The cap 40 fixes the rear wall 51 in the receiving groove 30 of the fastening device 1. The rear wall 51 sits firmly in the receiving groove 30, which is formed by the eccentric disk 20 and the base plate 11 of the mandrel 10. After the cap 40 has been fastened onto the eccentric disk 20, the rear wall 51 cannot be moved vertically. Furthermore, after the cap 40 has been attached, the eccentric disk 20 can no longer be rotated. The cap 40 forms a means preventing decoupling of the rear wall 51 and an additional means preventing rotation of the eccentric disk 20. Furthermore, horizontal displacement of the range hood housing 50 along the receiving groove 30 is impeded by the gravitational force of the range hood housing 50 and by friction between the range hood housing 50 and the receiving groove 30 and/or the base surface W.

FIG. 6 shows a perspective view of a range hood housing 50, which has a rear wall 51 with two cutouts 52. The cutouts 52 in the rear wall 51 are preferably arranged at the same height in the rear wall 51. To fasten the range hood housing 50 to a base surface W, such as a room wall, firstly the mandrel 10 and the eccentric disk 20 rotatably mounted on the mandrel 10 are fastened by means of a fastening screw to the base surface W. This is the only time that a tool is needed. Thereafter, the rear wall 51 of the range hood housing 50 is pushed through the cutouts 52 onto the two eccentric disks 20 until the rear wall 51 is inserted into the receiving groove 30 of the two fastening devices 1. To align the range hood housing 50 horizontally, this housing can, on account of the width of the cutouts 52, which is greater than the diameter of the eccentric disk 20, be displaced horizontally along the receiving grooves 30. To align the range hood housing 50 vertically, the eccentric disks 20 of the two fastening devices 1 can be rotated. After the range hood housing 50 has been aligned, the caps 40 are placed on the eccentric disks 20 of the two fastening devices 1 and are fastened there by means of the latching elements 42 on the cap 40. Removal of the range hood housing 50 is thus no longer possible. Only after the caps 40 have been removed can the range hood housing 50 be released from the fastening.

1-14. (canceled)

15. A fastening device for fastening a range hood housing of a range hood to a base surface, the fastening device comprising:
a mandrel fastened to the base surface;
an eccentric disk having an outer lateral area and rotabably arranged on the mandrel; and
a receiving groove formed, at least area by area, by the outer lateral area of the eccentric disk and to receive at least a section of the range hood housing.

16. The fastening device of claim 15, wherein the receiving groove is provided along at least one section of a circumference of the outer lateral area.

17. The fastening device of claim 15, wherein the mandrel has a base plate that forms, together with at least one section of the outer lateral area of the eccentric disk, the receiving groove.

18. The fastening device of claim 15, wherein the mandrel has a mandrel through-opening and the eccentric disk has an eccentric disk through-opening through which a fastening screw is guided.

19. The fastening device of claim 15, wherein the eccentric disk has an inner lateral area and wherein the mandrel has at least one latching projection to engage behind at least one edge at the inner lateral area of the eccentric disk in a form-locking manner.

20. The fastening device of claim 15, wherein the outer lateral area of the eccentric disk is shaped as a conical frustum.

21. The fastening device of claim 15, wherein the eccentric disk has a bore that runs in inclined relation to a rotational axis of the eccentric disk.

22. The fastening device of claim 21, wherein the bore runs perpendicularly to the rotational axis of the eccentric disk.

23. The fastening device of claim 15, further comprising a cap fastened to the eccentric disk in at least one of a form-locking manner and a force-locking manner.

24. The fastening device of claim 23, wherein the cap is shaped as a conical-frustum container.

25. The fastening device of claim 23, wherein the cap has an inner lateral area and wherein the cap has at least one latching element that is provided at the inner lateral area of the cap and that engages with at least one of projections, indentations, grooves and undercuts on the outer lateral area of the eccentric disk.

26. The fastening device of claim 23, wherein the cap has an open end and angled limb members that are arranged, at least area by area, at the open end of the cap and that are directed at least one of towards a central axis of the cap and away from the central axis of the cap.

27. The fastening device of claim 26, wherein the angled limb members are oriented perpendicularly to the central axis of the cap.

28. The fastening device of claim 15, wherein the outer lateral area of the eccentric disk has knurls.

29. The fastening device as of claim 25, wherein the inner lateral area of the cap has knurls.
